(19) United States
(12) Patent Application Publication
(10) Pub. No.: US 2015/0178780 A1
(43) Pub. Date: Jun. 25, 2015

(54) METHOD AND DEVICE FOR CHARGING FOR CUSTOMIZED SERVICE

(71) Applicant: SK TELECOM CO., LTD., Seoul (KR)

(72) Inventors: Seung-ji YANG, Seongnam-si (KR); Ki-mun KIM, Seongnam-si (KR)

(21) Appl. No.: 14/634,588

(22) Filed: Feb. 27, 2015

Related U.S. Application Data
(63) Continuation of application No. PCT/KR2013/007771, filed on Aug. 29, 2013.

(30) Foreign Application Priority Data
Aug. 31, 2012 (KR) 10-2012-0096778

(51) Int. Cl. G06Q 30/02; G06K 9/62

(52) U.S. Cl. CPC G06Q 30/0266; G06K 9/6267

(57) ABSTRACT

An apparatus for charging a user customized service includes: an image processor to receive image data of a user captured by an image capturer and to extract specific data from the image data; a user identifier to identify user identification data of the user based on the specific data; a service extractor to extract the user customized service to be offered to the user, based on the user identification data of the user; a service provider to receive information on the user customized service from a service storage unit and to provide the information to the user; and a service charger to calculate a service fee for the user customized service of the service provider by an exposure time ratio of the user customized service exposed to the user.

### CROSS-REFERENCE TO RELATED APPLICATION

The present application is a continuation of International Application No. PCT/KR2013/007771, filed Aug. 29, 2013, which is based upon and claims the benefit of priority from Korean Patent Application No. 10-2012-0096778, filed on Aug. 31, 2012 in Korea. The disclosures of the above-listed applications are hereby incorporated by reference herein in their entirety.

### TECHNICAL FIELD

The present disclosure relates to a method and an apparatus for charging for a user customized service based on image data of a user recorded by an image capturer.

### BACKGROUND

The statements in this section merely provide background information related to the present disclosure and do not constitute prior art.

In recent years, known out-of-home (OOH) media are turned faster into a digital OOH (DOOH) media, and particularly in the area of advertisement media exhibits the evolution toward DOOH advertisement system (hereinafter, a “digital signage”). The digital signage is currently installed in various public places such as subway station, shopping mall, and ground transportation stop depending on its purpose not only in a form of large-sized screen but also in a Kiosk type, gradually diversifying its place of application. Besides, the digital signage is being advanced in a form of providing a bidirectional service such that various information and content items can be exchanged with the user through an IT-based display, beyond the known unidirectional information provision. The inventor(s) has noted that this provides the users with a map service, user customized and locally-based advertisement for product purchase, coupon-linked service, and the like by user selection such as a touch of a display.

On the other hand, the digital signage, which provides the bidirectional advertisement service, currently provides a customized service based on a method in which a user actively participates through a touch screen or the like. The inventor(s) has, however, experienced that there are few ways to quantify and reflect the effect of such services in a monetary charge, and hence there is a need to provide a method for measuring the effect of an advertisement in a quantitative manner.

### SUMMARY

According to some embodiments, an apparatus for charging for a user customized service includes an image processor, a user identifier, a service extractor, a service provider, and a service charger. The image processor is configured to receive image data of a user captured by an image capturer and to extract specific data from the image pixel data. The user identifier is configured to identify user identification data of the user based on the specific data. The service extractor is configured to extract the user customized service to be offered to the user, based on the user identification data of the user. a service provider is configured to receive information on the user customized service from a service storage unit and to provide the information to the user. And the service charger is configured to calculate a service fee for the user customized service of the service provider by an exposure time ratio of the user customized service exposed to the user.

According to some embodiments, an apparatus for charging for a user customized service performs a method of charging for a user customized service includes receiving captured image data of a user captured by an image capturer and extracting specific data from the captured image data, identifying user identification data of the user based on the specific data, selecting the user customized service to be offered to the user, based on the user identification data of the user, receive information on the user customized service from a service storage unit and providing the information to the user, calculating a service exposure time during which the user customized service is exposed to the user, based on the image data of the user, and calculating a service fee for the user customized service by an exposure time ratio of the user customized service exposed to the user, based on the service exposure time.

The exposure time ratio may be a ratio of the exposure time to a total service time of the user customized service, and the service fee may be proportional to a value of at least one weighting factor which is set for each of the user identification data, multiplied by the exposure time.

The at least one weighting factor may include any one weight selected from the group consisting of a weight on a gender of the user, a weight on an age of the user, a weight on a race of the user, and any combinations thereof.

### DESCRIPTION OF DRAWINGS

FIG. 1 is a block diagram of an apparatus for charging for a user customized service according to some embodiments of the present disclosure.

FIG. 2 is a diagram of a table of target genders and target ages for advertisements of an arbitrary particular advertiser of the present disclosure.

FIG. 3 is a schematic diagram of a system for providing a user customized service, which employs an apparatus for charging for a user customized service according to some embodiments of the present disclosure.

FIG. 4 is a diagram of a step of extracting specific data corresponding to a face area of a user from image data of the user according to some embodiments.

FIG. 5 is a diagram of user consumption patterns by gender, age, and race for a plurality of users stored in a customer statistics unit according to some embodiments of the present disclosure.

FIG. 6 is a flowchart of a procedural process for a method of charging for a user customized service according to some embodiments of the present disclosure.

### DETAILED DESCRIPTION

Hereinafter, at least one embodiment of the present disclosure will be described in detail with reference to the accompanying drawings. In the following description of the at least one embodiment, detailed descriptions of known functions and configurations incorporated herein will be omitted for the purpose of clarity and for brevity.

Some embodiments of the present disclosure provide a method and an apparatus for charging for a user customized service, in which the user customized service is provided to a user by identifying user identification information based on image data of the user recorded by an image capturer, and a service fee is calculated by an exposure time ratio of the service exposed to the user, based on the image data of the user. As an exemplary embodiment of the present disclosure, an apparatus for charging for a user customized service is, for example, an automated terminal device installed in a public place such as airport, hotel, and department store, which can be easily accessed by the public. The automated terminal device receives selection information from a user through a touch screen (i.e., one of input units equipped in the automated terminal device), and provides a user customized service to the user based on the received selection information. An apparatus for charging for a user customized service according to some embodiments of the present disclosure further includes an image capturer, such that the device automatically identifies user information even without an active interaction of the user, such as a touching action on the touch screen, and provides a user customized service based on the identified user information.

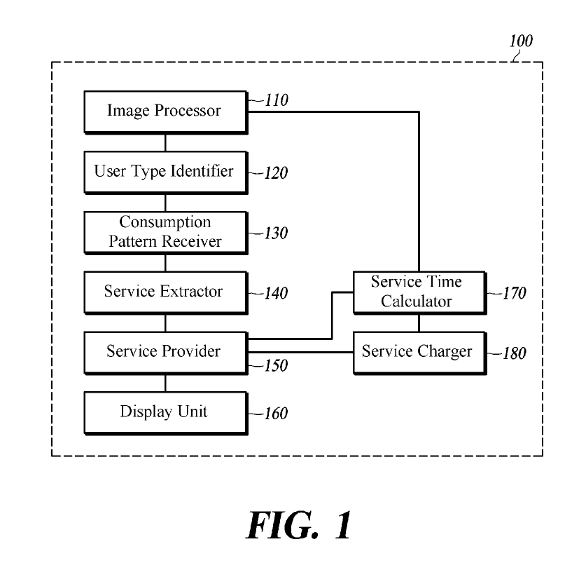

FIG. 1 is a block diagram of a charging apparatus 100 for charging for a user customized service charging according to some embodiments of the present disclosure.

The charging apparatus 100 includes an image processor 110, a user type identifier 120, a consumption pattern receiver 130, a service extractor 140, a service provider 150, a display unit 160, a service time calculator 170, and a service charger 180. Although it is described that, in some embodiments, the charging apparatus 100 includes the above-mentioned elements, those skilled in the art will appreciate that various modifications, additions and substitutions are possible, without departing from the spirit and scope of the claimed invention. Other components of the charging apparatus 100, such as each of the user type identifier 120, the consumption pattern receiver 130, the service extractor 140, the service provider 150, the service time calculator 170, and the service charger 180 is implemented by, or includes, one or more processors and/or application-specific integrated circuits (ASICs). The charging apparatus 100 comprises input units such as one or more buttons, a touch screen, a mic and so on, and additional output units besides a display unit 160 such an indicator and so on.

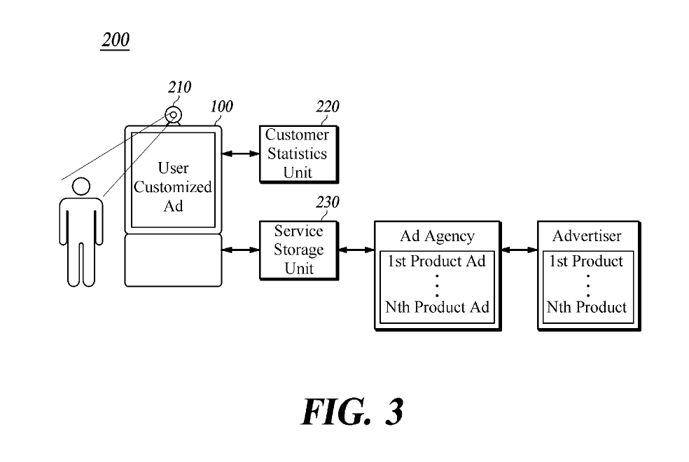

The image processor 110 receives image data of a user (i.e., a subject) captured by an image capturer (e.g., image capturer 210 in FIG. 3), and extracts from the image data specific data related to a user customized service in order to provide a user with the user customized service. For example, when the user is are detected (positioned) within a predetermined distance away from the image capturer, the image capturer captures (or records) an image or a video of the user. The image processor 110 receives the image data (i.e., the captured image) of the user from the image capturer, and extracts the specific data to be used as a determination reference for providing the user customized service to the user, based on the image data. In some embodiments, the specific data is a face area of the user in the image data of the user. The user identification information of the user can be identified based on the face area of the user extracted from the image data of the user. The image capturer includes one or more image camera censors and/or lens (e.g., a digital camera) to capture an image or a video of a subject (e.g., a user). The image capturer can be built in, or independently equipped with, the charging apparatus 100.

The image processor 110 divides the received image data into a plurality of pixels, and extracts an area (i.e., pixels) corresponding to the face area of the user's captured image from the divided pixels. That is, when the user is, partially or wholly, captured, the image processor 110 classifies respective data (i.e., pixels corresponding to the image data captured by the image capturer) included in the image data based on a preset classification range, and then divides, by a pixel unit, the classified data into a plurality of pixels to thereby extract the specific data including the face area of the user's captured image from the divided pixels. Herein, the extracted specific data corresponds to one or more pixels corresponding to face area of the user's captured image, among the divided pixels.

Upon extracting the data of the face area of the user's captured image from the divided pixels, the image processor 110 further extracts information on the eyes of the user's captured image from pixels of an area from the forehead to the neck excluding hairs. The image processor 110 checks (determines) whether a face alignment is performed by evaluating eyes' position in the user's captured image. That is, When both eyes of the user's captured image are not located in a horizontal position, the image processor 110 performs a face alignment in a manner that both eyes of the user's captured image are located at the horizontal position by adjusting the user's captured image by tilting and or rotating positions of the eyes of the usr's captured image in a forward or backward direction and/or a left or right clockwise direction. Upon determining that the eyes of the user are located at the horizontal position, the image processor 110 determines that the face of the user is aligned to face the front.

The user type identifier 120 identifies the user identification of the user based on the extracted specific data (i.e., pixels corresponding to a face area of the user's captured image). In other words, upon determining that the eyes of the user are aligned with the horizontal position so that the face of the user's captured image faces the front, the user type identifier 120 identifies the user identification information such as gender, age, and race of the user by using the specific data and pre-stored identification information.

The user type identifier 120 analyzes the extracted specific data by using a pattern matching algorithm to thereby determine a pattern of the user which is a subject captured by the image capturer. Herein, the pattern of the user indicates information used for identifying the user. The user type identifier 120 performs a pattern matching of pieces of identification information such as, for example, gender, age, and race of each of a plurality of users stored in the user type identifier 120 with the specific data of the user's captured image by using a pattern matching algorithm, and identifies the gender, the age, and the race of the user based on a result of the pattern matching. In other words, specific data items of a plurality of users and the pieces of identification information on gender, age, and race of a plurality of users actually acquired are stored in a database of the user type identifier 120, and when the specific data for an image of a new user is received, the user type identifier 120 performs the pattern matching of the pre-stored identification information with the specific data of the new user, and extracts identification information of a user with the highest probability from the pre-stored identification information of the specific data of the new user stored in the database of the user type identifier 120.

Although it is described that the user identification information identified by the user type identifier 120 according to some embodiments includes information on the gender, the age, and the race, some embodiments of the present disclosure are not limited to this scheme, but a plurality of pieces of information for identifying the user can be included as appropriate.

The consumption pattern receiver 130 interlocks with a customer statistics unit, and receives consumption pattern information for a plurality of users living and working in an area where the user is recorded (e.g., Seoul) from the customer statistics unit. The consumption pattern information includes information related to at least one of gender, age, and race of each of a plurality of users living and working in an area where the charging apparatus 100 is located. The consumption pattern information is stored in the customer statistics unit. Such consumption pattern information is provided by credit card or point card service providers. The consumption pattern receiver 130 determines a user customized service by using the received consumption pattern information. Further, by using consumption pattern information for gender, age, and race of each of a plurality of users, the charging apparatus 100 gains the consumption pattern of other users having the same or similar user identification information as that of the user who is provided with the user customized service, and thereby it can provide more accurate user customized service (e.g., advertisement service). For example, the other users indicate ones who have the same or similar consumption pattern of the user.

Although the consumption pattern information of a plurality of users received by the consumption pattern receiver 130 includes the amount of consumption, which indicates a consumption level of a plurality of users, and product of personal preference, which indicates a product purchased or viewed by a majority of the plurality of users, some embodiments of the present disclosure are not limited to this scheme, but the consumption pattern information includes various pieces of information from which the consumption pattern of the plurality of users can be acquired.

The service extractor 140 extracts a user customized service to be provided to a user, based on the user identification information and the consumption pattern information corresponding thereto. In other words, the service extractor 140 performs a matching of the consumption pattern information for gender, age, and race of each of a plurality of users living and working in an area where the charging apparatus 100 is located, by using the user identification information including the gender, the age, and the race of the user identified from the specific data, and extracts a set of services related to the consumption pattern information of other users having the same or similar user identification information as that of the user who is provided with the user customized service.

The service extractor 140 determines a correlation between the consumption pattern information of the other users having the same user identification information as that of the user who is provided with the user customized service and the set of services related to the consumption pattern information, and extracts a service having the maximum correlation value as the user customized service for the user. The number of services having the maximum correlation value are one or more services.

The user identification information for matching with the consumption pattern information is acquired from Equation 1.

I=(G,A, . . . )

G={g₁,g₂, . . . }

A={a₁,a₂, . . . }

Pᵢ={Gₚ,Aₚ, . . . } Equation 1

where GₚεG, AₚεA,

In Equation 1, I is the user identification information including various identification criteria such as gender and age, and is expressed as I=(G, A, . . . ). G, representing the gender of the user, is expressed as a set G={g₁, g₂, . . . } of one or more values for making a gender distinction. A, the age of the user, is expressed as a set A={a₁, a₂, . . . } of one or more values for classifying age. P is the user photographed by the image capturer, and the user P's identification information is expressed as P_{I}={Gₚ, Aₚ, . . . }. In other words, the identification information of a user P is obtained through gender value sets and age value sets of the users recorded by the image capturer.

In addition, the consumption pattern for gender, age, and race of each of a plurality of users living and working in an area where the charging apparatus 100 is located can be expressed by Equation 2.

T_{I}^{L}={B,C, . . . } Equation 2

In Equation 2, T_{I}^{L} is consumption pattern information of users having user identification information I including the gender and the age among people living in place L, and B and C are specific values of the consumption pattern information. In some embodiments, B and C are values respectively indicating the amount of consumption and the product of personal preference, but the specific values of the consumption pattern information are not limited to these values. The specific values B and C of the consumption pattern information are data obtained by statistically analyzing data from a plurality of users, which are generally average values thereof.

The correlation between the consumption pattern information of the users having the same or similar user identification as that of the user who is provided with the user customized service and the set of services related to the consumption pattern information is determined, and the service having the maximum correlation value is extracted by Equation 3.

$${S}_{target} = {argmax}_{S ∈ S} D ( {T}_{{P}_{l}}^{L} , S ) \qquad Equation 3$$

In Equation 3, S_{target} is the service having the maximum correlation value. In some embodiments, S_{target} is extracted by obtaining D(T_{PI}^{L}, S), i.e., the maximum correlation value between the consumption pattern information of users having identification information P_{I} of a user P recorded by the image capturer among a plurality of users living in a place L where there is the charging apparatus 100 and a service set S indexed based on the identification information. The service set S according to some embodiments basically includes an advertisement, but some embodiments of the present disclosure are not limited to this scheme, i.e., the service set S includes a plurality of services to be provided to the user.

The service provider 150 receives information on the extracted user customized service from a service storage device, and provides the service to the user through the display unit 160. When the service to be provided to the user is an advertisement, the service storage device receives an advertisement for a product under contract with a service provider (e.g., advertiser) from a service agency that provides the advertisement service, and when the advertisement for the product matches the user customized service, provides the advertisement to the user through the display unit 160.

The service time calculator 170 calculates a service exposure time during which the user customized service provided to the user is exposed to the user, based on the image data of the user captured by the image capturer. That is, the service time calculator 170 calculates a service exposure time between a time when the user receives the user customized service through the display unit 160 and a time when the user no longer receives the user customized service. The service exposure time is calculated as a time period (or time duration) between a moment when the user customized service is started to be provided to the user and a moment when it is detected that the user no longer exists in the image data received from the image capturer or when it is detected that the user's attention leaves the user customized service. Whether, e.g., the attention of the user leaves the service or the user is viewing another place may be, for instance, detected by using the viewing angle of the face of the user in the image.

The service exposure time is accumulated and stored for each of user identification information with respect to all users who are provided with the user customized service. For example, it is assumed that a first user who is provided with a first product advertisement is an Asian female in her 20's and the service providing time is 20 seconds exposed to the first user. It is also assumed that a second user who is provided with the first product advertisement is an Asian female in her 30's and the service providing time is 25 seconds exposed to the second user. As a result, the service time calculator 170 calculates the service exposure time for the advertisement in consideration of one or more elements of, for example, an age, a gender and a race, in a manner that 20 seconds for 20's and 25 seconds for 30's are accumulated for the age identification information, 20+25=45 seconds is accumulated for the gender identification information, and 45 seconds is accumulated for the Asian (race) identification information.

The service exposure time is accumulated in this manner for each elements of the user identification information. For example, with respect to the user identification by gender, service exposure times are respectively accumulated for male and female.

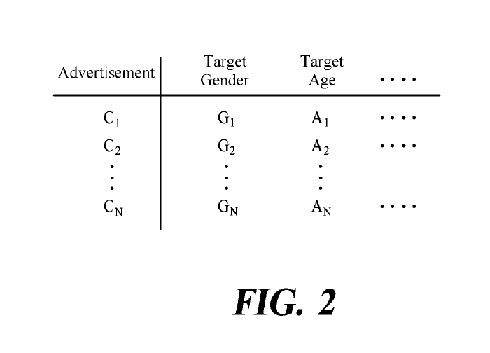

FIG. 2 is a diagram of a table of target genders and target ages for advertisements of an advertiser.

As shown in FIG. 2, when it is planned to store N advertisements C₁ to C_{N} for the advertiser and display the advertisements to users through the charging apparatus 100 for a user customized service charging, pieces of information on target gender and target age to display the advertisements are stored for each advertisement Cₙ. Such targeting information is specified by the advertiser and stored together with the corresponding advertisements. Some embodiments of the present disclosure do not limit a method for obtaining such targeting information to a specific method.

When the total advertisement time for which an arbitrary advertisement Cₙ is displayed is defined as Tₙ, and a time for which the advertisement Cₙ is displayed for target gender Gₙ is defined as tₙ^{G}, a hit rate hₙ^{G} indicating that the advertisement Cₙ successfully targeted the gender Gₙ can be expressed as Equation 4.

$${h}_{n}^{G} = \frac{{t}_{n}^{G}}{{T}_{n}} \qquad Equation 4$$

When a time during which the advertisement Cₙ is displayed to target gender Aₙ is defined as tₙ^{A}, a hit rate hₙ^{A} indicating that the advertisement Cₙ is successfully targeted the gender Aₙ can be expressed as Equation 5.

$${h}_{n}^{A} = \frac{{t}_{n}^{A}}{{T}_{n}} \qquad Equation 5$$

Hit rates for the targeting information other than the gender and the age are obtained in the similar manner.

The service charger 180 calculates a service fee (e.g., advertisement fee) according to an exposure time ratio of the service exposed to the user by using the service exposure time calculated based on the image data of the user by the service time calculator 170 with respect to a user customized service (i.e., advertisement in this example) of a particular advertiser.

The exposure time ratio according to the user identification information (i.e., gender and age) can be obtained by Equations 4 and 5, and a total exposure time ratio (hit rate) can be calculated by Equation 6, according to the exposure time ratios calculated in the above manner.

$${H}_{avg} = \frac{1}{N} {\sum }_{n = 1}^{N} [ {W}_{n} \cdot ( {w}_{n}^{G} \cdot {h}_{n}^{G} + {w}_{n}^{A} \cdot {h}_{n}^{A} + … ) ] \qquad Equation 6$$

In Equation 6, w^{G}+w^{A}+ . . . =1, and W₁+ . . . 1 and W_{N}=1.

In Equation 6, w^{G} is a weight by gender for the advertisement Cₙ, w^{A} is a weight by age for the advertisement Cₙ, and a sum of all the weights of the user identification information including the gender, the age, and the race for the advertisement Cₙ is 1. Wₙ is a weight for the advertisement Cₙ in the whole advertisement, and a sum of all the weights for the advertisements is 1.

As indicated in Equation 6, the service charger 180 calculates a target advertisement hit rate H_{avg} by using a value proportional to a value (w^{G}hₙ^{G}+w^{A}hₙ^{A}+ . . . ) of at least one weighting factor (w^{G}, w^{A}, and the like) set for each of the user identification information, multiplied by the corresponding exposure time ratio (hₙ^{G}, hₙ^{A}, and the like). As indicated in Equation 6, the at least one weighting factor that is set for each of the user identification information includes any one weight selected from the group consisting of a weight on the gender of the user, a weight on the age of the user, a weight on the race of the user, and any combinations thereof.

When the target advertisement hit rate H_{avg} for a particular advertiser is determined as Equation 6, an advertisement fee Vₜ is calculated by additionally calculating an effect of the target advertisement by Equation 7.

Vₜ=V(1+αH_{avg}) Equation 7

In Equation 7, V is a basic service fee (e.g., basic advertisement fee) of the whole advertisement according to a display time of the advertisement, a is a weight indicating a portion of the target advertisement hit rate in the calculation of the advertisement fee. In Equation 7, the total advertisement fee Vₜ is calculated by reflecting the target advertisement hit rate H_{avg} calculated by Equation 6 on the advertisement fee. That is, the advertisement fee of a particular advertiser is calculated by summing the fixed basic advertisement fee and a value proportional to an average of values of respective service weighting factors, each calculated for each user customized advertisement service C₁˜Cₙ of the particular advertiser, multiplied by the exposure time ratio.

FIG. 3 is a schematic diagram of a system 200 for providing a user customized service, which employs the charging apparatus 100 for a user customized service according to some embodiments of the present disclosure.

The system 200 for providing a user customized service employing the device 100 for charging for a user customized service according to some embodiments includes the user customized service charging apparatus 100, an image capturer 210, a customer statistics unit 220 and a service storage unit 230. Other components of the system 200, the customer statistics unit 220 is implemented by, or includes, one or more processors and/or application-specific integrated circuits (ASICs). The image capturer 210 includes one or more image camera censors and/or lens to capture an image of a subject (e.g., a user), is implemented by, or includes, one or more processors and/or application-specific integrated circuits (ASICs) to process the captured image of the subject. The image capturer 210 includes one or more memories (e.g., a ROM, a RAM, an EPROM memory, an EEPROM memory, and a flash memory) to record the captured image of the subject. The service storage unit 230 is implemented by, for example, a non-transitory computer-readable recording medium including magnetic media such as a hard disk, a floppy disk, and a magnetic tape, optical media such as a CD-ROM and a DVD, magneto-optical media such as an optical disk, and a hardware device configured especially to store and execute data related the captured and/or recoded image, such as a ROM, a RAM, an EPROM memory, an EEPROM memory, and a flash memory.

The charging apparatus 100 for a user customized service includes the image capturer 210 for capturing and/or recording an image of a user, identifies the user identification information including gender, age, and race, based on the image data of the user's captured image collected through the image capturer 210, receives consumption pattern information of a plurality of users living and working in an area where the user is located, and provides a user customized service by matching user identification information of the plurality of user and the consumption pattern information of the plurality of users.

The charging apparatus 100 classifies the image data of the user's captured image by a pixel unit, divides the classified the image data into a plurality of pixels, and extracts an area corresponding to the face area of the user's captured image from the divided pixels. Thereafter, the charging apparatus 100 further extracts information on eyes of the user's captured image from the classified and divided pixels. When both eyes of the user's captured image are not located at a horizontal position, the charging apparatus 100 adjusts the user's captured image by tilting and or rotating the positions of the eyes of the user's captured image in a forward or backward direction and/or a left or right clockwise direction such that both eyes of the user's captured image are located at the horizontal position. Upon determining that the eyes of the user's captured image are located at the horizontal position, the charging apparatus 100 determines that the face of the user is spatially transformed to face the front.

The charging apparatus 100 performs a pattern matching of the image data of a plurality of users stored in the charging apparatus 100 to identification information on, for example, gender, age, and race of each of a plurality of users actually acquired, based on the data of the extracted and spatially transformed face of the user, and extracts identification information of a user with the highest probability.

The charging apparatus 100 performs a matching of the user identification information and the consumption pattern information for a gender, an age, and a race of each of a plurality of users living and working in an area where the charging apparatus 100 is located, and extracts a set of services related to the consumption pattern information of other users having the same or similar user identification information as that of the user who is provided with the user customized service. Thereafter, the charging apparatus 100 determines a correlation between the consumption pattern information of the users having the same user identification information as that of the user who is provided with the user customized service and the set of services related to the consumption pattern information, selects a service having the maximum correlation value as the user customized service for the user, and provides the selected service to the user.

Although the user customized service charging apparatus 100 shown in FIG. 3 is introduced as a Kiosk type, some embodiments of the present disclosure are not limited to this scheme, but can be manufactured in various forms including a large-sized screen depending on the purpose and the installation site.

The customer statistics unit 220 stores in a database, the consumption pattern information of a plurality of users living and working in an area where there is the charging apparatus 100, and provides the consumption pattern information stored in the database to the charging apparatus 100. The customer statistics unit 220 receives the consumption pattern information by gender, age, and race of a plurality of users living and working in an area where the charging apparatus 100 is located from credit card or point card service providers, stores the received consumption pattern information in a database. Then, in response to a request from the charging apparatus 100 for the consumption pattern information of a plurality of users, the customer statistics unit 220 provides the stored information to the charging apparatus 100.

The customer statistics unit 220 periodically updates the consumption pattern information of the plurality of users, and when there is no consumption pattern information of a user stored in the database for a predetermined time, updates or deletes the consumption pattern information of the user.

When the user customized service is extracted by the charging apparatus 100, the service storage unit 230 receives information on the service, and provides the stored service to the charging apparatus 100. Although the user customized service is described as an advertisement in FIG. 3, some embodiments of the present disclosure are not limited to this scheme, but the user customized service includes a plurality of customized services for the users.

The service storage unit 230 is connected to device(s) of an advertiser and an advertisement agency, and periodically receives information on a specific advertisement. When introducing a specific product to a user in a form of customized service through the charging apparatus 100, the advertiser produces an advertisement through the advertisement agency, and the advertisement agency provides the produced advertisement to the service storage unit 230. Thereafter, when the stored advertisement is determined to be the user customized service, the service storage unit 230 provides the stored advertisement to the charging apparatus 100.

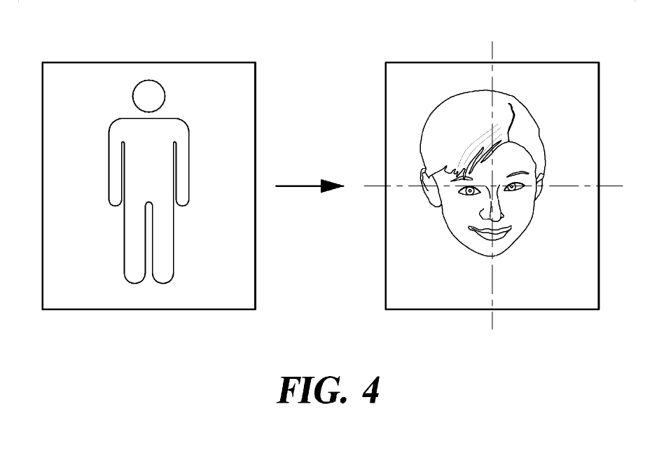

FIG. 4 is a diagram of a step of extracting specific data corresponding to a face area of a user from image data of the user according to some embodiments.

As shown in FIG. 4, when image data of a user within a recording range is received from the image capturer, a whole or a part of the user is included in the image data of the user. The data on the face area of the user is necessary to identify the user identification information, and the charging apparatus 100 for a user customized service classifies the image data of the user by pixel unit through the image processor 110, and extracts an area corresponding to the face area of the user from the divided pixels. Thereafter, the charging apparatus 100 further extracts information on eyes of the user from the data in the range corresponding to the face area of the user, and when both eyes of the user are not located at a horizontal position, adjusts positions of the eyes such that both eyes of the user are located at the horizontal position. Upon determining that the eyes of the user are located at the horizontal position, the device 100 for charging for a user customized service determines that the user customized service gets an attention from the user at a given time.

As shown in FIG. 4, the image data captured by the image capturer is information on a image showing a front view of the user. The charging apparatus 100 extracts the face area from a body of the user by dividing the image data into a plurality of pixels, further detects (or extracts) the positions of the eyes from the extracted face area, and performs a compensation (i.e., adjusts the user's captured image) such that the detected face of the user's captured image faces the front.

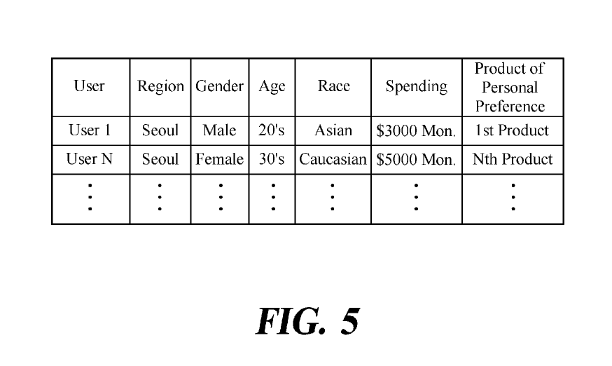

FIG. 5 is a diagram of user consumption patterns by gender, age, and race for a plurality of users stored in the customer statistics unit 220 according to some embodiments of the present disclosure.

As shown in FIG. 5, the consumption pattern information for a plurality of users stored in the customer statistics unit 220 shows information for, for example, gender, age, and race of each of a plurality of users in the corresponding area (e.g., Seoul), and includes information on the amount of consumption and the product of personal preference for each user. For example, a user 1 is an Asian male in his 20's, spending 3000 USD/month, and prefers a first product as the product of personal preference. When it is identified that the identification information of a user to be provided with the user customized service through the charging apparatus 100 for a user customized service is an Asian male in his 20's, the information of the user 1 stored in the customer statistics unit 220 applies as an identification reference for extracting the user customized service for the user to be provided with the user customized service.

In the case of a user N, the user N is a Caucasian female in her 30's, spending 5000 USD/month, and prefers an Nth product as the product of personal preference. Similarly, when it is identified that the identification information of a user to be provided with the user customized service through the charging apparatus 100 for a user customized service is a Caucasian female in her 30's, the information on the user N stored in the customer statistics unit 220 applies as an identification reference for extracting the user customized service for the user to be provided with the user customized service.

In other words, the charging apparatus 100 is configured to receive the consumption pattern information on gender, age, and race of a plurality of users stored in the customer statistics unit 220, to acquire the consumption pattern information of a plurality of users matching the information of another user, and to provide the user customized service to the another user based on the matching consumption pattern information.

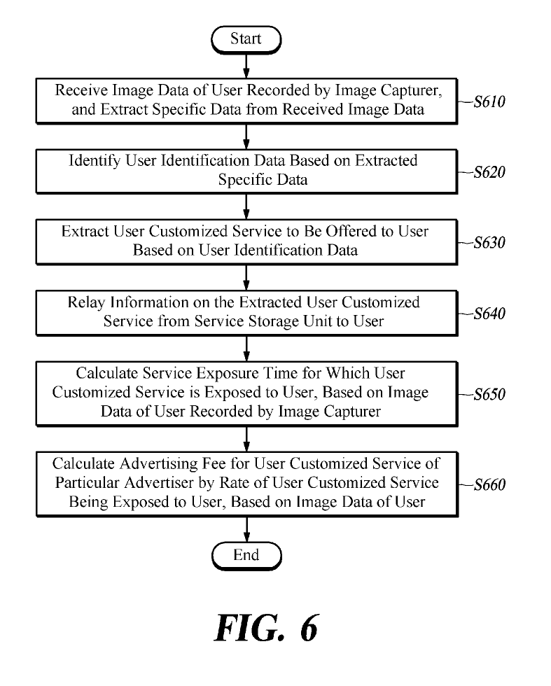

FIG. 6 is a flowchart of a procedural process for a method of charging for a user customized service according to some embodiments of the present disclosure.

As shown in FIG. 6, a method of charging for a user customized service according to some embodiments includes receiving image data of a user captured by an image capturer and extracting specific data from the received image data (S610), identifying user identification information of the user based on the extracted specific data (S620), extracting a user customized service to be provided to the user based on the user identification information (S630), receiving the extracted user customized service from the service storage unit and providing the user customized service to the user (S640), calculating a service exposure time during which the user customized service is exposed to the user, based on the image data of the user captured by the image capturer (S650), and calculating an advertisement fee by an exposure time ratio of the user customized service exposed to the user, based on the image data of the user's captured image (S660).

The step of extracting the specific data (S610), the step of identifying the user identification information (S620), the step of extracting the user customized service (S630), the step of providing the user customized service to the user (S640), the step of calculating the service exposure time (S650), and the step of calculating the advertisement fee (S660) correspond to operations and functions respectively performed by the image processor 110, the user type identifier 120, the service extractor 140, the service provider 150, the service time calculator 170, and the service charger 180 presented in FIG. 1. Detailed descriptions for operations and functions of each corresponding process shown in FIG. 6 are applied to corresponding descriptions of each elements shown in FIG. 1, as described above with respect to FIG. 1, and further descriptions of FIG. 6 is therefore omitted solely for concise description of the present disclosure.

According to some embodiments of the present disclosure as described above, a service such as a user customized advertisement is provided to a user by identifying user identification information based on image data of the user recorded by an image capturer, and a service fee is calculated by an exposure time ratio of the service exposed to the user, based on the image data of the user. In addition, the service fee to be charged to a service provider is reasonably determined by calculating the service fee (e.g., advertisement fee) with respect to the service exposure effect, after setting service targets such as age and gender as the user identification information, based on each of the set user identification information.

Although exemplary embodiments of the present disclosure have been described for illustrative purposes, those skilled in the art will appreciate that various modifications, additions and substitutions are possible, without departing from the spirit and scope of the claimed invention. Specific terms used in this disclosure and drawings are used for illustrative purposes and not to be considered as limitations of the present disclosure. Therefore, exemplary embodiments of the present disclosure have been described for the sake of brevity and clarity. Accordingly, one of ordinary skill would understand the scope of claimed invention is not limited by the explicitly described above embodiments but by the claims and equivalents thereof.

What is claimed is:

1. An apparatus for charging a user customized service, the apparatus comprising:
an image processor configured to receive image data of a user captured by an image capturer and to extract specific data from the image data;
a user identifier configured to identify user identification data of the user based on the specific data;
a service extractor configured to extract the user customized service to be offered to the user, based on the user identification data of the user;
a service provider configured to receive information on the user customized service from a service storage unit and to provide the information to the user; and
a service charger configured to calculate a service fee for the user customized service of the service provider by an exposure time ratio of the user customized service exposed to the user.

2. The apparatus of claim 1, further comprising:
a service time calculator configured to calculate a service exposure time during which the user customized service is exposed to the user, based on the image data of the user.

3. The apparatus of claim 2, wherein the exposure time ratio is a ratio of the service exposure time to a total service time of the user customized service.

4. The apparatus of claim 3, wherein the service fee is proportional to a value of at least one weighting factor being set for each of the user identification data, multiplied by the exposure time ratio.

5. The apparatus of claim 4, wherein the at least one weighting factor includes at least one weight selected from the group consisting of a weight on a gender of the user, a weight on an age of the user, a weight on a race of the user.

6. The apparatus of claim 1, wherein
the service fee includes a first service fee and a second service fee,
the first service fee is a fixed basic service fee, and
the second service fee is proportional to the exposure time ratio.

7. The apparatus of claim 1, wherein
the service fee includes a first service fee and a second service fee,
the first service fee is a fixed basic service fee, and
the second service fee is proportional to an average of values of respective service weighting factors, each calculated for each user customized service of the service provider, multiplied by the exposure time ratio.

8. The apparatus of claim 1, wherein the image capturer is configured to include
one or more image camera censors to capture an image of the user, and
one or more memories to record the captured image of the user.

9. A method performed by an apparatus for charging a user customized service, the method comprising:
receiving captured image data of a user captured by an image capturer and extracting specific data from the captured image data;
identifying user identification data of the user based on the specific data;
extracting the user customized service to be offered to the user, based on the user identification data of the user;
receive information on the user customized service from a service storage unit and providing the information to the user;
calculating a service exposure time during which the user customized service is exposed to the user, based on the image data of the user; and
calculating a service fee for the user customized service by an exposure time ratio of the user customized service exposed to the user, based on the service exposure time.

10. The method of claim 9, wherein
the exposure time ratio is a ratio of the exposure time to a total service time of the user customized service, and
the service fee is proportional to a value of at least one weighting factor being set for each of the user identification data, multiplied by the exposure time ratio.

11. The method of claim 10, wherein the at least one weighting factor includes at least one weight selected from the group consisting of a weight on a gender of the user, a weight on an age of the user, a weight on a race of the user.

12. The method of claim 9, wherein
the service fee includes a first service fee and a second service fee,
the first service fee is a fixed basic service fee, and
the second service fee is proportional to the exposure time ratio.

13. The method of claim 9, wherein
the service fee includes a first service fee and a second service fee,
the first service fee is a fixed basic service fee, and
the second service fee is proportional to an average of values of respective service weighting factors, each calculated for each user customized service, multiplied by the exposure time ratio.

14. The method of claim 9, wherein the image capturer is configured to include
one or more image camera censors to capture an image of the user, and
one or more memories to record the captured image of the user.
